(19) United States
(12) Patent Application Publication
(10) Pub. No.: US 2015/0295801 A1
(43) Pub. Date: Oct. 15, 2015

(54) Distributed Network Delay and Jitter Monitoring Using Fixed and Mobile Network Devices

(71) Applicant: BLUE OCTOPUS MATRIX INC., Los Gatos, CA (US)

(72) Inventors: Tony Vega, Los Gatos, CA (US); Raymond S Krummen, San Jose, CA (US); Kishan Shenoi, Saratoga, CA (US)

(21) Appl. No.: 14/436,478

(22) PCT Filed: Oct. 25, 2013
(86) PCT No.: PCT/US2013/066950

§ 371 Date: Apr. 16, 2015

Related U.S. Application Data
(60) Provisional application No. 61/718,598, filed on Oct. 25, 2012.

(51) Int. Cl. H04L 12/26

(52) U.S. Cl. CPC H04L 43/087; H04L 43/106; H04L 43/12

(57) ABSTRACT

Inclusion of a simple time-transfer module in client devices and judicious deployment of time-servers in the network enable a network management system to observe, record, and predict network issues. In a wireless network every mobile device can be a probe and monitoring of all parts of the network on a continuous basis can be achieved.

### CROSS-REFERENCE TO RELATED APPLICATION

This application claims a benefit of priority under 35 U.S.C. 119(e) from co-pending provisional patent application U.S. Ser. No. 61/718,598, filed Oct. 25, 2012, the entire contents of which are hereby expressly incorporated herein by reference for all purposes.

### FIELD OF THE INVENTION

Embodiments of the present invention relate generally to monitoring the operation of communication networks. This is achieved utilizing end-point stations as probes that communicate with suitably deployed time-servers on a continual basis for purposes of establishing performance metrics that are used to quantify network loading and identify fault conditions. Historical analysis of network loading is necessary to optimize network equipment deployment and growth strategies.

### DESCRIPTION OF THE RELATED ART

Traditional approaches to monitoring communication networks assume that the network elements comprising the network can monitor their own performance and report loading/over-loading conditions to a network management system. In many cases specialized test equipment is utilized in the field for troubleshooting purposes. However, such testing methods are useful for establishing network performance parameters only for the limited duration of the equipment deployment and only apply to the conditions that exist during the test.

Most network elements such as routers that are deployed in communications networks maintain an estimate of the occupancy of their communications links. For instance, if an Ethernet interface provides the capability of transmitting 1 Gbit/s and information traffic consumes, on the average, 500 Mbit/s, the link is considered to be loaded at 50%, the remaining transmission bandwidth comprises idle signal or fill-in information that can be replaced by traffic if necessary. If the link loading is 100% then the link cannot carry any additional traffic and can thus result in congestion whereby information traffic can be delayed or even discarded. This delay and/or discard operation represents an impairment of the traffic carrying capability of the network element. Often routers maintain queues for scheduling transmission of traffic packets and can estimate loading by examining the fill level of the queues. Coordinating the information from multiple network elements can provide a partial picture of the network loading conditions.

For troubleshooting wireless network access issues, specialized equipment is deployed, on a temporary basis, in the vicinity of the base-station suspected of sub-par performance or deployed in a mobile device such as a car or truck that is driven around in the vicinity of the base-station. This manual/semi-manual approach suffices to address static problems that persist regardless of time-of-day or demand for network resources. Problems that may manifest themselves in one geographical area that have a root cause involving multiple geographical areas (base-stations) may not be uncovered by this approach. Observations of network conditions made by such deployed test equipment are available only on a temporary basis while the test equipment is in operation and cannot be used for continual monitoring purposes.

### SUMMARY

A series of nodes are connected over a communication network using bi-directional transmission links. For convenience the network is logically separated into segments. Server nodes, referred to here as time-servers, that derive time from a common reference source such as GPS are deployed at judicious locations within the network.

Client nodes are disbursed around the network edge. For example, in a wireless network the client nodes can be the mobile stations such as phones and tablets. In a wired network such as that of an enterprise, the client nodes can be the desktop computers on a local area segment of the network or mobile computers accessing the local area network using wireless communications.

The client nodes interact with the server nodes using a time-transfer protocol such as NTP or PTP or similar protocol suitable for exchanging time-stamps of events between client and server. The events correspond to the time-of-arrival and time-of-departure of designated packets exchanged by the server and client. The exchange of time-stamps can be the basis for the client nodes setting their internal time-clock. The client nodes may also have alternative time sources including, but not limited to, GPS, to set their time-clock. The time-stamps associated with the time-of-departure and time-of-arrival of a particular packet provide an estimate of the transit delay of the packet from the server (or client) to the client (or server).

The time-stamps exchanged are also reported to a centralized network management server that includes these time-stamps in a database along with particulars of the client and server and additional ancillary information including the identities of the server and client; the geographical location of the client if it is a location-enabled mobile wireless device; geographical location of the intermediate network elements such as, in the case of wireless networks, cellular base-stations or WiFi access points; RF (radio frequency) signal strength parameters; particulars of the route taken by the packet through the network;

Computing suitable metrics from the time-stamps and analyzing the historical trend thereof can be used to identify network issues including, but not limited to, over-loading and under-utilization. Data mining techniques and graphical depiction of performance metrics derived from the data can be used by operators to better understand and analyze network performance. The time-stamps provide a way to analyze the metrics in terms of the temporal evolution of performance as well as ascertain simultaneity of events that may occur in different parts of the network, physical and/or logical.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a conventional layout of entities in a wireless network (prior art).

FIG. 2 depicts the deployment of time-servers (201, 202, 203) at judicious points in the network.

FIG. 3 depicts the logical connection of all probe and server entities to a centralized network management system.

FIG. 4 schematically illustrates the exchange of packets between client and server nodes identifying the transit delay δ₁₂ 412 and δ₃₄ 414.

FIG. 5 depicts the logical view of the segmented network between nodes.

FIG. 6 illustrates how the mobile clients in a wireless network can move and thereby home into a different base-station as time evolves resulting in a dynamic loading pattern.

FIG. 7 depicts clients in a wired network such as a corporate communication network.

FIG. 8 provides an example of the method of association of time-stamps with physical and logical data.

FIG. 9 provides an example of the progression of one-way delay versus time. This could be the estimated transit delay over a network segment or the delay experienced by a mobile device as it traverses the mobile network.

FIG. 10 provides an example of moving, or windowed, minimum, mean and maximum delays for a mobile client as it is handed off from base-station to base-station.

FIG. 11 provides an example of moving average jitter versus time for a mobile client as it is handed off from base-station to base-station.

FIG. 12 provides an example of raw delay data seen by an ensemble of devices homing in to a particular cell tower.

FIG. 13 provides an example of moving averages (minimum, mean and maximum) delays seen by an ensemble of devices homing in to a particular cell tower.

FIG. 14 provides an example of jitter versus time as seen by an ensemble of devices homing in to a particular cell tower.

For clarity, identical reference numbers have been used, where applicable, to designate identical elements that are common between figures. It is contemplated that features of one embodiment may be incorporated in other embodiments without further recitation.

### DETAILED DESCRIPTION

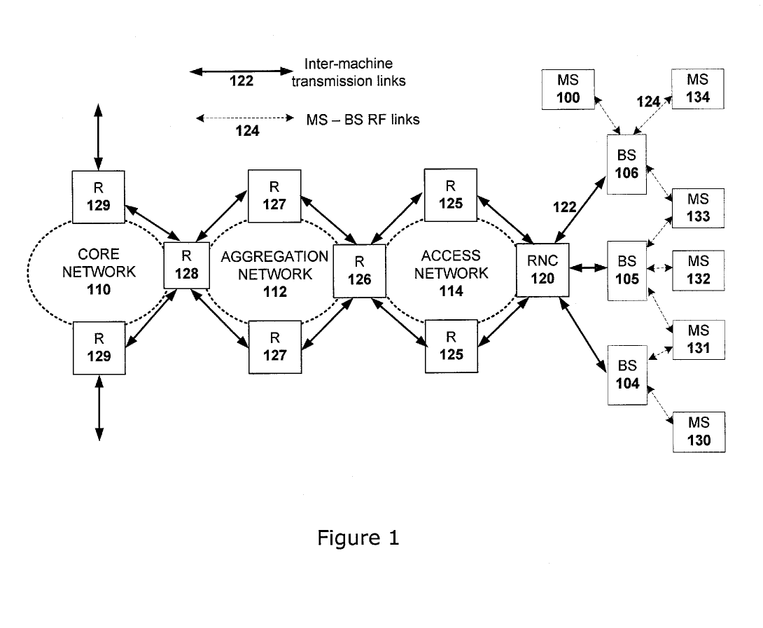

FIG. 1 depicts conventional transmission connectivity in a wireless network used for providing cellular telephony. A typical mobile client MS 130 establishes an RF (radio frequency) link with a base-station (e.g. BS 104). Each base-station homes into a Radio Network Controller (RNC) such as RNC 120. The RNC communicates back into the wireless operator's network. FIG. 1 represents just the transmission aspect of the network. Wireless telephony will have other functions such as switching, call-control and links to other networks and these are not shown in FIG. 1. It is common, but not mandatory, for transmission networks to be segmented as shown in FIG. 1 in terms of access segment 114, aggregation segment 112, and core segment 110. Other methods of segmenting networks into logical sections are possible. It is common for the different segments to implemented as rings with each node in the ring being a network element such as a router since modern transmission methods are predominantly packet oriented though vestiges of circuit-switched (aka TDM) segments remain from pre-existing deployments.

FIG. 1 indicates but a few routers R 125 in the access ring. There may be one or more routers R 126 that serve as interconnection points between the access network and the next higher lever, namely the aggregation network. The aggregation network may itself be implemented as a ring with routers such as R 127 and have certain routers such as R 128 that serve as interconnection points between the aggregation networks and the next higher level, namely the core network. Whereas only three levels of networks are shown, there is no particular limitation as to the number of levels. The switching machines associated with the call control are generally in the core network. Thus a telephone call involving a particular mobile telephone MS 130 will involve transmission between the MS 130 and the RNC 120 via a BS (e.g. 104) and then between the RNC 130 and the linkage router R 126 over the access network and then between R 126 and the linkage router R 128 over the aggregation network and from there to the switching center (not shown in FIG. 1) which is in the core network. In practice there could be multiple routes between 130-120-126-128, each with a different path and number of network elements involved. It is preferable, though not mandatory, that the return path follow the same route as the forward path.

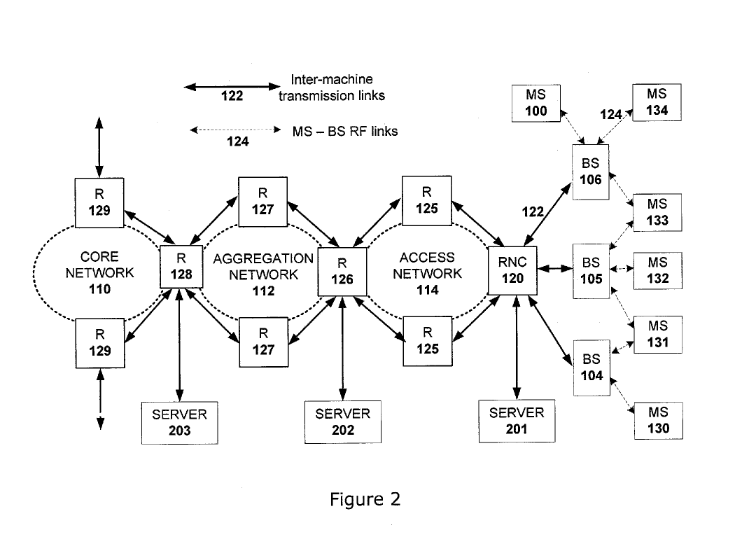

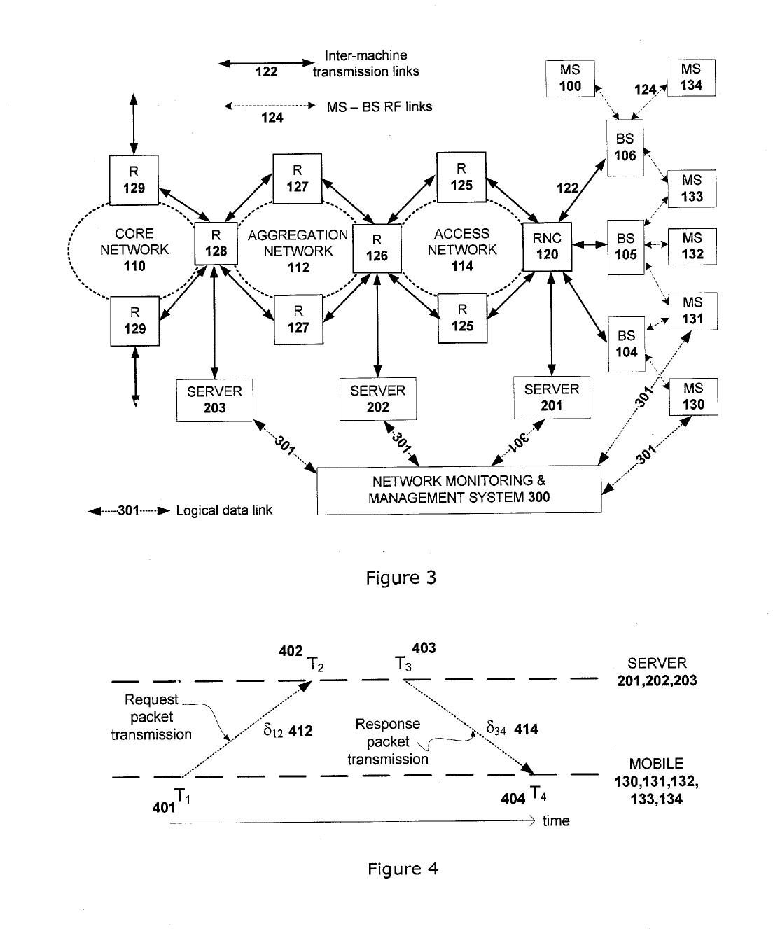

In one embodiment of the invention depicted in FIG. 2, time-servers are judiciously deployed in the network, preferably at the junction points of network segments, possibly logical. In FIG. 2 Server 201 is deployed adjacent to the RNC 120; Server 202 is deployed adjacent to router R 126 representing the junction point of access and aggregation segments; Server 203 is deployed adjacent to router R 128 representing the junction between aggregation and core network segments. Additional servers can be deployed to facilitate logical segmentation of the network from the viewpoint of loading analysis. The mobile stations MS (e.g. 130) are equipped with time client software so as to communicate with the time-servers using the chosen time-transfer protocol. For specificity, NTP is the chosen protocol in this description. The mobile stations and time-servers are all in communication with a centralized management system 300 using conventional internet protocol methods such as TCP/IP and this communication is indicated in FIG. 3 by logical data links 301.

Server nodes are referenced to global Coordinated Universal Time (UTC) via a satellite time reference, e.g., Global Navigation Satellite System (GNSS) such as Global Positioning System (GPS), GLObal NAvigation Satellite System (GLONASS), Galileo, Compass/Beidou, Wide Area Augmentation System (WAAS) or similar, or via a terrestrial RF broadcast time reference, e.g., WWVB, JJY or similar, or via mobile wireless base-station signals, e.g., CDMA, GSM, WiMAX or similar. Server nodes may include a client node to derive UTC from other servers over the network in hierarchical fashion in cases where the primary satellite or RF reference is unavailable. Client nodes derive absolute time from one or more server nodes which distribute timing packets over the network. Client nodes may also derive time from satellite and RF references. Server and Client Nodes may also derive position from GNSS, ground-based RF navigation systems (e.g., LORAN), RF triangulation techniques including TDOA and Signals of Opportunity, inferred from connected cell tower identification (position lookup from cell tower database) or, in the case of fixed assets, known from a previous survey. Network topology is unconstrained.

There are several methods for distributing time over the network e.g., IEEE1588 Precision Time Protocol (PTP), and Network Time Protocol (NTP). The method used is a network design choice of the operator and also depends upon the application. PTP is often the protocol of choice for network operators to distribute time to their mobile backhaul infrastructure. NTP is a common choice for distribution of time to endpoint devices over IP and Internet. RTP (Real Time Protocol) is typically used to synchronize real-time services over IP such as VoIP and video-conferencing and can, with some modifications, be used for time-transfer applications as well.

Each of these protocols involves the time-stamping of packets upon creation of the packet, representing the time-of-departure and the time-stamping of the packet upon the reception of the packet representing the time-of-arrival. In NTP the typical sequence of events follows the progression depicted in FIG. 4. The mobile, e.g. 130, can ping a designated server with a “request” packet. A time-stamp, T₁ 401, is struck by the mobile at the time-of-departure of this request packet. The packet leaves the mobile and traverses the network over some route to the designated server and the transit delay of the packet is δ₁₂ 412. The time server, e.g. 201, strikes a time-stamp T₂ 402, representing the time-of-arrival of the request packet at the time server. Provided that the time server and the mobile client clocks are synchronized, the difference (T₂−T₁) is equal to the transit delay from client to server for that packet. The server, e.g. 201, generates and sends a response packet. A time-stamp, T₃ 403, is struck by the server at the time-of-departure of this response packet. The packet leaves the server and traverses the network over some route back to the mobile client and the transit delay of the packet is δ₃₄ 414. The mobile, e.g. 130, strikes a time-stamp T₄ 404, representing the time-of-arrival of the response packet at the client. Provided that the time server and the mobile client clocks are synchronized, the difference (T₄−T₃) is equal to the transit delay from server to client for that packet.

The accuracy of the time-stamps depends upon many factors in the network such as network delay, jitter and packet loss. In general, implementations attempt to time-stamp packets as accurately as possible and attempt to reduce or eliminate delay variation in terms of the time the transmitted packet was generated (TS) to the time it is transmitted on the network and similarly from the time the received packet physically entered from the network to the time the packet was time-stamped (TR). (TR-TS) for any particular packet is the estimate of the one-way delay. Several algorithms exist for deriving timing over the network and all require a two-way exchange of time-stamped packets from the client to the server (upstream) and time-stamped packets from the server to the client (downstream). For each protocol the time-stamp format may be different. It is well known that for network-based time distribution, the accuracy is limited to the difference in transit delay in the two directions, T_{ASYM}, divided by 2 (accuracy approximately=T_{ASYM}/2) and also depends upon the jitter (transit delay variation from nominal) and packet loss in the network. Very good accuracy can be obtained by the server or client device when connected to GPS or similar. In these cases, the network protocol may still be used to calculate network delays but uses the GPS reference time instead of using the protocol's time derivation algorithm.

Once (system) time is established by the client running on the mobile device (e.g. MS 130), the mobile client can act as a monitor of delay, jitter and packet loss based on packets exchanged with the time servers (e.g. Server 201). This exchange between mobile clients and time servers is conducted on a continual basis. Each exchange is reported back to the network management center. The network management computer maintains a data-base with entries exemplified by FIG. 8. Denoting by TS the sending time (T₁ or T₃) and by TR the reception time (T₂ or T₄) of a transmitted packet, the relevant entries in the data base include, but are not limited to, the transmission and reception time, a serial number (SN) for the packet, the identity and location of the client, the identity of the server, and miscellaneous information.

Clients (and Servers that include client functions) can sample delays from multiple servers simultaneously, or over time in sequence at same or different rates. Information can also be gathered for various packet sizes and various COS or TOS packet markings. The client can also collect delay and jitter data for multiple protocols, multiple logical connections, multiple qualities of service and may or may not be application aware. The client stores the raw upstream and downstream delays and timestamps in its persistent or dynamic database associated with the device. The delay and timestamp information may be further processed by the device itself to generate statistical information such as moving or windowed averages, maximums, minimums, differences, jitter, as well as generate threshold crossing alerts such as when mean delay exceeds a minimum threshold for a given period of time. The client can also track packet loss rates with the various protocols. The statistics may be further processed to form metrics such as Mean Opinion Score (MOS) and R-Factor for digital voice, or ITU Y-1541 Network Performance parameters.

Some network timing nodes consist of both client and servers and operate in a hierarchy. In the parlance of PTP, these nodes are known as Boundary clocks. The client in the boundary clock may derive timing from a grandmaster that has GPS as its absolute reference. The choice of which grandmaster or boundary clock any client function references at any time is outside the scope of this description, however, in general the timing protocol will qualify the clock source and will use the “best” master clock that is available. For instance, in NTP, there is the concept of a Stratum hierarchy with the lower the Stratum number, the better the reference. The reference quality among servers of the same stratum may be determined by NTP using metrics of reachability, delay, offset and dispersion.

In mobile networks, when a handoff occurs in an operator network between towers sharing similar backhaul paths, the delay changes may be on the order of microseconds or tens of microseconds. However in intra-operator handoffs to towers with different backhaul paths, instantaneous delay changes can be in 100 s to 1000 s of microseconds. Inter-operator or inter-technology handoffs between carrier networks and public networks can experience substantial delay changes into the 10 s, perhaps 100 s of milliseconds. The quality of the connection for voice or video conferencing can be severely impacted, if not impaired, by these changes in delay.

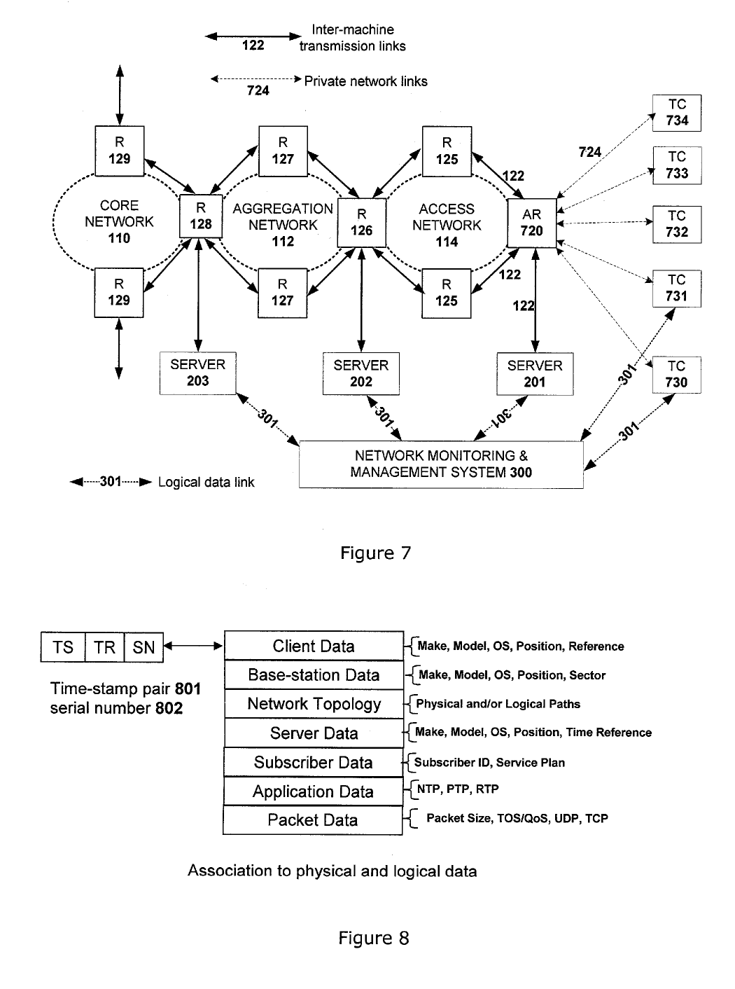

In wireless networks the gathering of the delay data collected by the mobile device is accompanied with the association of the delay data with relevant physical and logical information such as device position, cell tower ID, cell sector, hardware and software make, model and revision for the infrastructure including the mobile device itself. All of the above information may monitored by the centralized network monitoring system over the network as shown in FIG. 7 and processed in order to obtain:

Delay and Jitter statistics and metrics associate with, but not limited to the following:
Subscriber
Cellular device/handset or access device; for example:
   Motorola, Nokia, Samsung, etc.
   Handset, femtocell
Logical Network; for example:
   MPLS, VLAN
Physical topology; for example:
   Ring, Mesh, Linear
Physical location/geography
   Mobile Device location
   Infrastructure location
Cellular Network Generation; for example:
   GSM, CDMA, CDMA2000, WiMAX, TD-SCDMA, WLAN, other
Cellular Network Operator; for example:
   Verizon, Sprint, T-Mobile, AT&T
Infrastructure
   Basestation
      Type and manufacturer
   Aggregation Node
      Router, Switch and type and manufacturer
Network Time Protocol; for example:
   PTP, NTP, RTP
Network Layer/Protocol; for example:
   TCP/IP
   UDP
Application; for example:
   VoIP
   Video-Conferencing
   Data transfer
Packet Properties; for example:
   Size/Payload
   Class of Service (COS) or Type of Service (TOS) markings
Dates and Times
   Classification by specific Time, Day, Date or range thereof.

Association of the delays with any of the above may be done be the client device itself in combination with stored database. For instance, the delay data may be annotated with GPS position from the device itself along with the Cell tower ID and sector information. The make and model of the cell tower may be later associated to the delay information through a query to a database.

In FIG. 7, the monitoring server queries the clients and servers for delay statistics. The monitoring servers may or may not be co-located with the network time servers. The monitoring servers may query the client and server nodes for status, delay and statistical information using SNMP, FTP or HTML protocols interfaces. Storage of historical delay data can be collocated with the server or to a remote storage position. Post-Processing of real-time or historical delay data can be done by the monitoring server or by an external analysis application to associate the time-stamps with additional information such as cell tower make, model, location, network topology, etc.

This method permits monitoring of delay and jitter for individual mobile devices and for time varying ensembles of mobile clients connected to base-stations that change as mobile clients are handed to, or handed from the base-station. FIG. 6 indicates the dynamic behavior of wireless networks. Whereas the base-stations are generally fixed in geographical locations, the number, and identity, of mobiles connected to a particular base-station can change over time. Likewise, a particular mobile station could be handed off from one to another base-station over time.

For example, the operator may wish to query the data base for ensemble call quality for all 3G voice connections for every Friday in the past year in the city of Phoenix for those users with Android-based cellular devices manufactured by Motorola. Such a query can be further constrained to the period of 8 AM-12:00 PM in the downtown area. And again further constrained to evaluate delay metrics for the access portion of the network as opposed to full-end to end delays and further categorized as those connections made over a particular base-station make and model, such as Ericsson BTS 2111 or RBS 3202.

Delay metrics can also be collected based on subscriber such as delays for the month of May for subscriber n. This can be further subdivided to all 3G connections for any service, or by a particular service class, such as voice, video, data. For instance the operator may want to examine the delays for UDP packets of sizes ranging from 576 Bytes to 1518 Bytes.

Typically cellular devices are within 1-2 km of the cell tower of the base-station. The cell tower precise position is known and therefore the device is within 3 us-6 us of the cell tower. If the precise position of the device and connected tower, is known through surveyed, GNSS or other RF techniques, then the time-of-flight delay can be estimated to 100 ns or better. This delay can then be distinguished from the network delays. Delays can be further associated to the cell sector. In cellular networks, some base-stations may be single sector, but also often multi-sector. Depending upon the method of delivering data and the position of the devices in the network, local interference and weather, distance from the base-station as the data rate may vary with signal strength.

In addition to the monitoring of statistics, the cellular device tracks the number of timing packets transmitted and received and the operator can discount these packets from the data plans so that the subscriber is not charged for the timing packets used for the operator's monitoring of the network. Similarly for the requests for raw or processed delay data.

As indicated above, associating mobile client delay data with various physical and logical information enables a mobile network monitoring method for mobile service providers that is not available in the prior art.

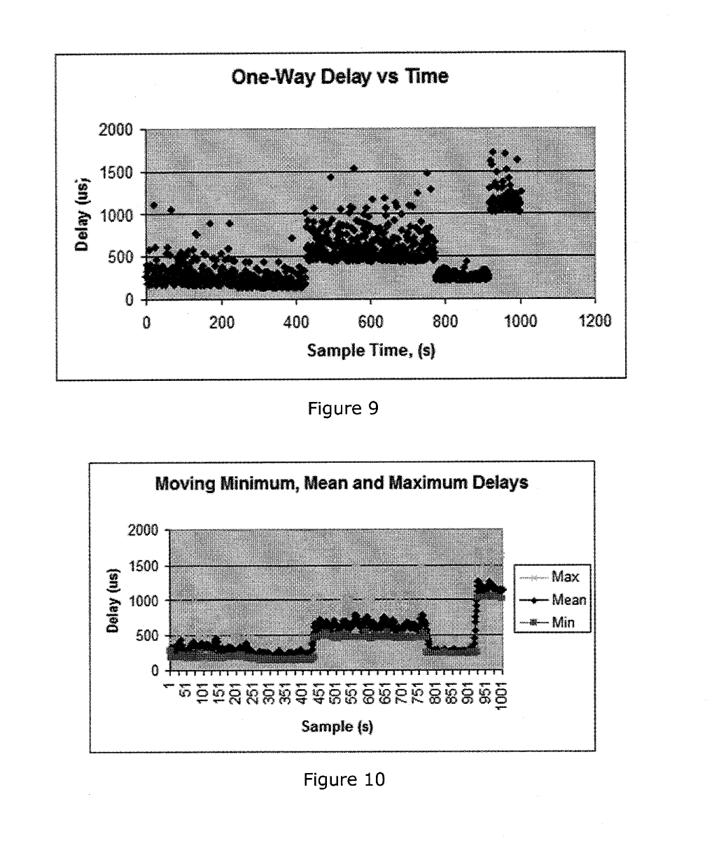

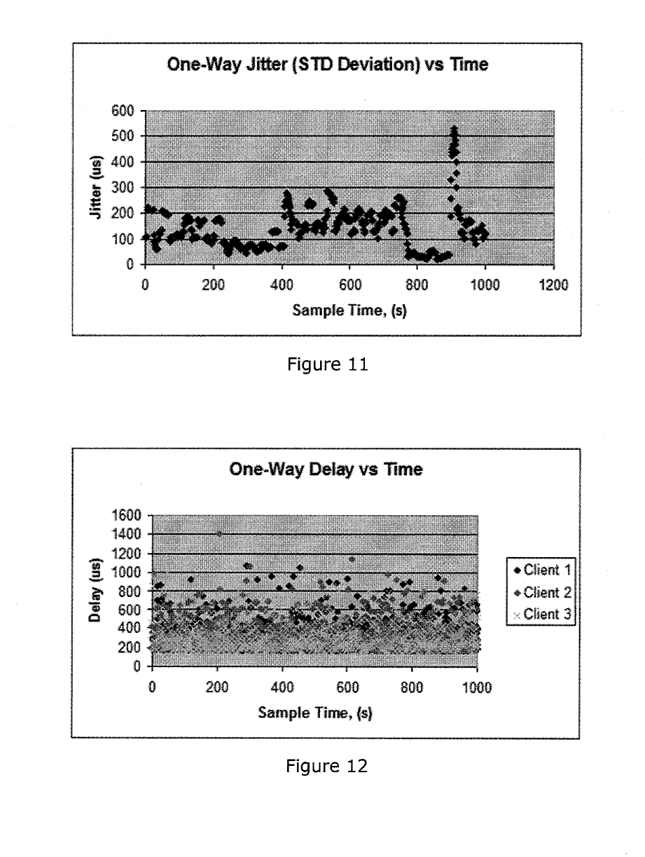

In one application a particular mobile station may be monitored as it moves around within an extended geographical area. Consider a mobile 130 that collects and reports data regarding its TS and TR time-stamps related to its communication with server 201. The delay estimate is computed as (TR−TS). FIGS. 9-11 show raw delay, moving minimum, mean, maximum and jitter as a mobile client traverses a cellular network. Delay samples are taken once per second. Handoffs occurred at seconds 248, 427, 773 and 916. Significant delay changes are evident as well as changes to the magnitude of the jitter with each handoff. Instantaneous delays can also be seen when networks are reconfigured such as occurs during network failovers.

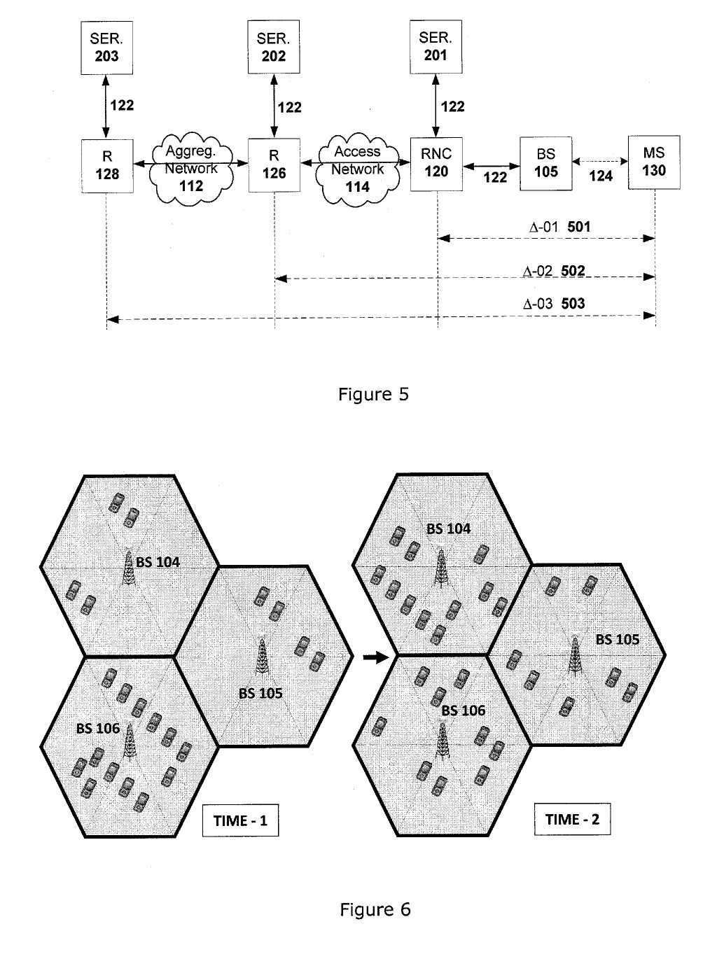

In another application suppose the goal is to monitor the performance of the access network segment 114 between RNC 120 and router R 126. For this the data used to develop the metrics involves packet exchanges between all mobiles that are associated with RNC 120 and time servers 201 and 202. With reference to FIG. 5, time-stamped packets can develop transit delay Δ-01 501 between a mobile 130 and RNC 120 (Server 201) and transit delay Δ-02 502 between mobile 130 and router R 126 (Server 202) and consequently an estimate of transit delay between RNC 120 (Server 201) and router R 126 as the difference between Δ-02 and Δ-01. The time-stamps available provide estimates for the transit delay for both directions of transmission independently.

In FIG. 9 an example of the progression of one-way delay is provided. Of interest is the information that is gleaned from the sequence. Specifically, the following properties apply:

A. Mean delay increases with load.
B. Standard deviation of delay increases with load.

Consequently, the network management system can establish loading estimates using these one-way delay estimates. For example, with reference to FIG. 9, the loading up to time ˜450 s is LOW, between ˜450 s and ˜750 s the loading is MEDIUM, and the loading between ˜750 s and ˜900 s the loading is LOW, and the loading between ˜900 s and ˜1000 s the loading is HIGH. Using suitable metrics the loading level can be estimated to a finer granularity than LOW/MEDIUM/HIGH.

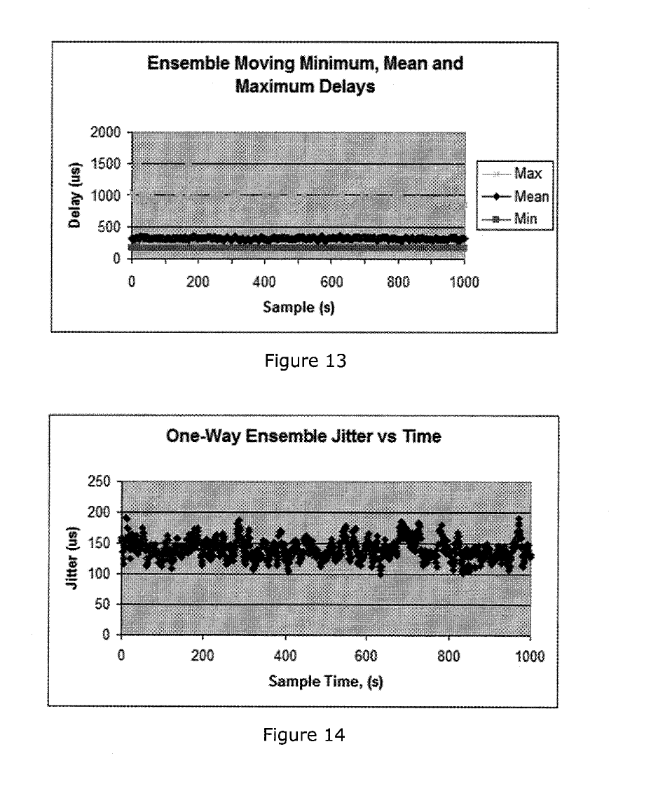

In another application, the measurements made from mobiles connected to a particular base-station to a particular server can be used to characterize the behavior of the base-station. FIGS. 12-14 show raw delay, moving minimum, mean, maximum and jitter for and ensemble mobile client connected to a single cell tower. Delay samples are taken once per second. No transients are seen and the behavior is constant to within a reasonable standard deviation. This indicates that the base-station is behaving properly and the statistics computed can be used as thresholds to determine base-station issues at some point in the future.

The literature in metrology provides additional metrics that can be computed over selected data. First, the data base can be searched using a particular set of parameters. For example, the search parameters could be all records associated with base station “X” (e.g. 104) and server “Y” (e.g. 201). Suppose the time-stamp data extracted is for the transit delay from a mobile to the server. That is the value of T₁ (401) is subtracted from T₂ (402) to give “ρ”. The server time is generally considered to be the most accurate and stable, so this value of “ρ” is associated with time t=T₂ (402). This procedure allows us to create a sequence of numbers that can be expressed as {ρ(t); t=T₂} corresponding to the entries in the data base. For convenience the data may be restricted to a particular time period such as a day or week or month; the value of T₂ can be used to restrict the data to this chosen interval. Now the values of T₂ in this set may not be uniformly spaced in time. A common approximation is to decide on a suitable sampling interval τ₀ and then construct an equivalent sequence that is representative of a uniformly spaced sampling-time grid of t₀ by establishing

$$x ( n {τ}_{0} ) = average \{ ρ ( {T}_{2} ) ; \vert {T}_{2} - n {τ}_{0} \vert \leq \frac{{τ}_{0}}{2} \}$$

That is, the new sequence {x(nτ₀)} represents the average of the values of “ρ” whose time-index value (T₂) is within one-half sampling time unit from n·τ₀. This new sequence corresponds to a uniform sampling-time grid and conventional formulae for timing metrics such as TDEV/TVAR, MTIE/MRTIE, etc. can be applied. For reference, the following formulas apply for a data sequence of N points. Suppressing the “τ₀” in the sequence index for notational simplicity, the MTIE formula is

$$MTIE ( τ = n \cdot {τ}_{0} ) = {max}_{i = 0}^{N - n} \{ {max}_{k = 1}^{k = i + n - 1} ( x ( k ) ) - {min}_{k = i}^{k = i + n - 1} ( x ( k ) ) \}$$

or, equivalently,

$$MTIE ( τ = n \cdot {τ}_{0} ) = {max}_{i = 0}^{N - n - 1} \{ {max}_{k = 1}^{k = n} [ \vert x ( i + k ) - x ( i ) \vert ] \} .$$

The formula for TDEV is

$${( TDEV ( τ = n {τ}_{0} ) )}^{2} ≅ \frac{1}{6 {n}^{2} ( N - 3 n + 1 )} {\sum }_{j = 1}^{N - 3 n + 1} {( {\sum }_{i = j}^{n + j - 1} ( x ( i + 2 n ) - 2 x ( i + n ) + x ( i ) ) )}^{2} ( TVAR )$$

The formula for TDEV is shown without the square-root on the right-hand-side; this is the formula for the square of TDEV, namely TVAR.

The importance of TDEV and MTIE, in addition to the simple mean and standard deviation is that they provide metrics as a function of “observation time” that in turn provides information regarding persistence, periodicity, and duration of congestion that is bursty in nature.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” or “mechanism for” or “step for”. Sub-generic embodiments of the invention are delineated by the appended independent claims and their equivalents. Specific embodiments of the invention are differentiated by the appended dependent claims and their equivalents.

What is claimed is:

1. A method, comprising: monitoring a communication station functioning as a sensing probe that is communicating with a time-server.

2. The method of claim 1, further comprising establishing performance metrics using a time-transfer protocol.

3. The method of claim 1, further comprising quantifying network loading.

4. The method of claim 1, further comprising identifying fault conditions.

5. The method of claim 1, further comprising analyzing historical network loading.

6. The method of claim 5, further comprising optimizing network equipment deployment.

7. The method of claim 1, wherein monitoring includes continually monitoring.

8. The method of claim 1, wherein monitoring includes intermittently monitoring.

9. The method of claim 1, wherein monitoring includes monitoring delay and monitoring jitter.

10. A method of operating a communication network, comprising the method of claim 1,

11. A apparatus, comprising:
a time-server; and
a time-transfer module communicatively coupled to the time-server.

12. The apparatus of claim 11, further comprising a plurality of time-transfer modules communicatively coupled to the time-server.

13. The apparatus of claim 11, further comprising a plurality of time-servers communicatively coupled to the time-transfer module.

14. The apparatus of claim 11, wherein the time-transfer module is located within an end-point station.

15. The apparatus of claim 14, wherein the end-point station is a mobile user device.

16. The apparatus of claim 11, further comprising a centralized network management server communicatively coupled to the time-server.

17. The apparatus of claim 11, wherein the time-server is located at a junction point between segments of a communication network.

18. A communication network, comprising the apparatus of claim 1.
